(19) United States
(12) Patent Application Publication
(10) Pub. No.: US 2007/0250336 A1
(43) Pub. Date: Oct. 25, 2007

(54) SYSTEMS AND METHODS FOR SOCIAL NETWORKING

(76) Inventor: Soohad Khoury, Redmond, WA (US)

Correspondence Address: RUTTLER LAW LLC, 1122 EAST PIKE STREET, # 1131, SEATTLE, WA, 98122, US

(21) Appl. No.: 11/697,738

(22) Filed: Apr. 8, 2007

Related U.S. Application Data
(60) Provisional application No. 60/745,370, filed on Apr. 21, 2006.

(51) Int. Cl. G06Q 10/00

(52) U.S. Cl. 705/1

(57) ABSTRACT

This invention relates generally to social networking, and more specifically, to systems and methods for bridging an online space and an offline physical venue. In one embodiment, the invention includes a system including an online space, the online space configurable to establish a member account for at least one member, the member account configurable to being associated with personal information, the online space configurable to permitting online interaction among the at least one member; a physical venue, the physical venue configurable to being a social place with access limited to the at least one member, the physical venue being configurable to permit physical interaction among the at least one member, and an integration system, the integration system configurable to permit online interaction between members physically present at the physical venue and between members physically present at the physical venue and members using on the online space.

### PRIORITY CLAIM

This application claims the benefit of U.S. provisional patent application 60/745,370 filed on Apr. 21, 2006. The foregoing application is incorporated by reference in its entirety as if fully set forth herein.

### FIELD OF THE INVENTION

This invention relates generally to social networking, and more specifically, to systems and methods for bridging an online space and an offline physical venue.

### BACKGROUND OF THE INVENTION

People have a general desire to meet other people who share similar interests. For instance, business people are interested in networking with potential clients, partners, and suppliers. Persons new to town are interested in finding friends having similar hobbies. Singles are interested in finding a partner having a common lifestyle and goals. Indeed, these are but a few examples where people desire to meet others who share similar interests.

However, meeting others with similar interests is increasingly problematic in our society. One issue is that individuals are becoming more specialized in their interests and we are living in larger populations. Thus, the sheer number of people makes it less probable that one individual with a particular interest will meet another individual having the same interest. To compound the problem, the anonymity of our larger population makes it difficult to fully trust other people and openly network. Further, social barrier norms prevent individuals from interacting in situations where they are otherwise in close proximity to one another. In a sense, this situation is paradoxical given that so many individuals can live in such close proximity to others yet still feel isolated.

Particular physical venues have been established, such as bars and coffee shops, that have gained tremendous popularity because of their ability to address the paradox and permit individuals to associate in a local setting within a complex society. Although the venues improve the situation, they still leave many unsolved problems. For instance, there is still uncertainty as to who fellow venue patrons are, what their interests are, and how trustworthy they are. Furthermore, venues often propagate social barrier norms whereby people are generally precluded from approaching others. Thus, in a particular coffee shop with thirty or so individuals at separate tables, uncertainty and social barrier norms may prevent two individuals having common interests from meeting just like ships passing in the night.

To improve upon the situation, online meeting spaces have been introduced whereby individuals can efficiently meet other individuals having common interests. Indeed, online meeting spaces have exploded in popularity boasting millions of users in a matter of months. Online meeting space popularity can be explained by their ability to remove social barrier norms and eliminate uncertainty of interests. Indeed, online users are encouraged to meet other online users and make their interests very clear up front. Despite their undeniable popularity, online meeting spaces suffer from tremendous drawbacks. First, they increase uncertainty as to trustworthiness because it is difficult to be sure exactly who is on the other end of an online communication. Second, they facilitate physical isolation by permitting individuals to communicate from remote and private locations without ever having to physically interact.

In short, it is difficult to meet other individuals sharing common interests for various reasons including increased population, specialization, uncertainty, and social barrier norms. Physical venues provide some solution to this problem because they permit individuals to associate in localized environments within a larger population. However, physical venues still suffer from uncertainty and propagate social barrier norms. Online meeting spaces reduce uncertainty as to interests and remove social barrier norms; however online meeting spaces augment uncertainty as to trustworthiness and facilitate isolation. Therefore, although desirable results have been achieved, there is much room for improvement. What is needed, therefore, are systems and methods for bridging an online space and an offline physical venue.

### SUMMARY OF THE INVENTION

This invention relates generally to social networking, and more specifically, to systems and methods for bridging an online space and an offline physical venue. In one embodiment, the invention includes a system including an online space, the online space configurable to establish a member account for at least one member, the member account configurable to being associated with personal information, the online space configurable to permitting online interaction among the at least one member; a physical venue, the physical venue configurable to being a social place with access limited to the at least one member, the physical venue being configurable to permit physical interaction among the at least one member, and an integration system, the integration system configurable to permit online interaction between members physically present at the physical venue and between members physically present at the physical venue and members using on the online space.

### BRIEF DESCRIPTION OF THE DRAWINGS

Embodiments of the present invention are described in detail below with reference to the following drawings:

FIG. 1 is a block diagram of a system for bridging an online space and an offline physical venue, in accordance with an embodiment of the invention;

FIG. 2 is a block diagram of a method for bridging an online space and an offline physical venue, in accordance with an embodiment of the invention; and

FIG. 3 is a block diagram of a system for bridging an online space and a plurality of physical venues, in accordance with an embodiment of the invention.

### DETAILED DESCRIPTION

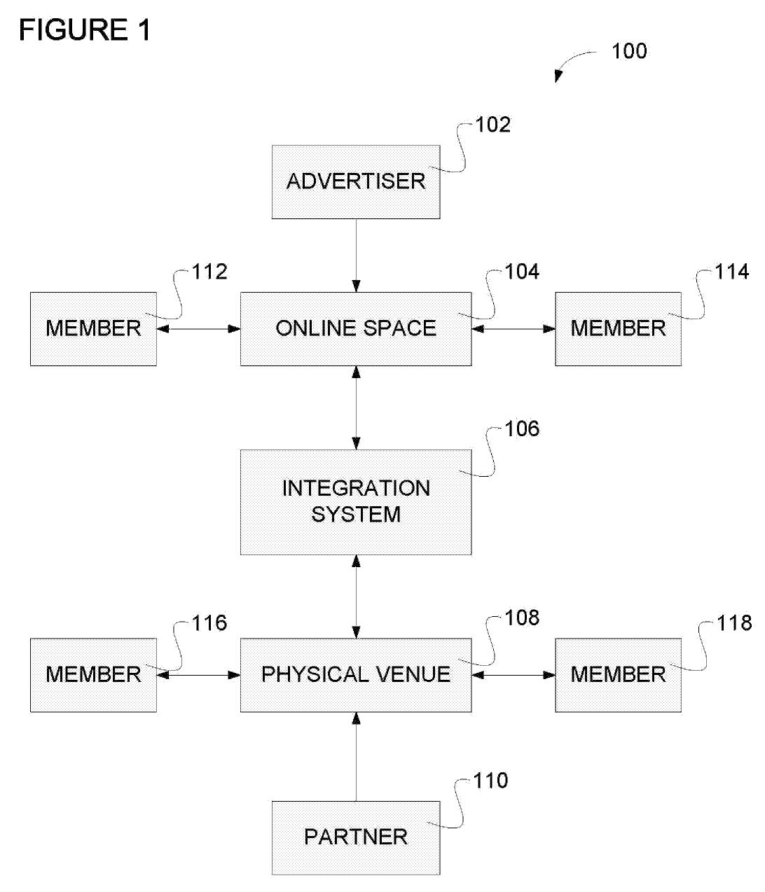

This invention relates generally to social networking, and more specifically, to systems and methods for bridging an online space and an offline physical venue. Specific details of certain embodiments of the invention are set forth in the following description and in FIGS. 1-3 to provide a thorough understanding of such embodiments. The present invention may have additional embodiments, may be practiced with or without one or more of the details described for any particular described embodiment, or may be practiced with any combination of the details described for any particular embodiment.

FIG. 1 is a block diagram of a system for bridging an online space and an offline physical venue, in accordance with an embodiment of the invention. In one embodiment, system 100 includes an online space 104, a physical venue 108, an integration system 106, a plurality of members 112, 114, 116, 118, an advertiser 102, and a partner 110. The system 100 may be used for relationship seeking, friend seeking, business networking, or any other social purpose.

In one embodiment, the online space 104 is an internet application that permits online communication between a plurality of members 112, 114. In one particular embodiment, the plurality of members 114 create a user account on the online space 104. The user account may include information such as username, password, name, address, age, occupation, criminal record, picture, marital status, gender, citizenship, or any other useful information. In one particular embodiment, the user account includes a membership fee. In a further embodiment, the online space 104 is configurable to permit each of the plurality of members 112, 114 to filter, search, review, and communicate with each other or other members. In various embodiments, the communication is in the form of any of text messaging, electronic mail, telephone, picture messaging, chat, or any other medium of communication. In one particular embodiment, the online space 104 provides limited non-member guest services.

In another embodiment, the physical venue 108 is an offline physical venue that permits physical interaction or communication between a plurality of members 116, 118. In various embodiments, the offline physical venue 108 is any of a bar, restaurant, lounge, club, theatre, event or any other outdoor or indoor venue. In one particular embodiment, the members 116, 118 have established an account on the online space 104 and utilize the account to gain access to the offline physical venue 108. Alternatively, the physical venue 108 offers limited non-member services. Access to the offline physical venue 108 permits the members 116, 118 to participate in entertainment, communication, business negotiations, consuming alcoholic beverages, games, learning, or any other activity. In one particular embodiment, the physical venue 108 further includes member services such as valet parking, personal introductions by staff, private meeting rooms, internet, television, business services, discounts, or other useful service.

In yet another embodiment, the integration system 106 is configurable to integrate the offline space 104 and the physical venue 108. In one particular embodiment, the integration system 106 provides the plurality of members 112, 114 the ability to determine which members 116, 118 are physically present or intending to be physically present at the physical venue 108. The ability to determine which members 116, 118 are physically present at the physical venue 108 provides the plurality of members 112, 114 the opportunity to review information regarding the members 116, 118 and either communicate with, schedule an appointment with, or physically arrive at the physical venue 108 and meet with the members 116, 118. In one particular embodiment, the integration system 106 is configurable to provide automatic notification when a particular member 116, 118 is physically present or intends to be physically present at the physical venue 108. In another particular embodiment, the integration system 106 is configurable to permit members 112, 114 themselves to indicate an intent to be present or actual presence at the physical venue 108. In yet another particular embodiment, the integration system 106 provides certain security measures to optionally limit accessible user information to all or a portion of the information on an individual or aggregate basis.

In a further embodiment, the integration system 106 is configurable to permit the plurality of members 116, 118 to filter, search, and review information and communicate with the plurality of members 112, 114 while present at the physical venue 108. In certain embodiments, the plurality of members 116, 118 are able to respond to incoming communications, schedule appointments for meetings, or invoke security measures to prevent others from accessing information regarding themselves. In a further embodiment, the integration system 106 is configurable to permit the plurality of members 118 to filter, search, and review information and communicate with one another at the physical venue 108 without being required to physically make contact with one another. In certain embodiments, the plurality of members 116, 118 are able to respond to communications, set up a physical meeting, or invoke security measures to prevent further communications or information sharing.

In one embodiment, the capability of determining which members are present at the physical venue 108 is provided by a check-in process prior to entrance. In one particular embodiment, the plurality of members 116, 118 carry an identification to permit other members to access further information about them on the online space 104. In certain embodiments, the identification is an ID contained on a label, glass, or electronic transmitter. In yet a further embodiment, the plurality of members 116, 118 carry a tracking device to assist in determining physical location. In an alternative embodiment, the integration system 106 is configurable to provide status settings so that any of the plurality of members can indicate whether they are available for communication. In other embodiments, any of the plurality of members 112, 114 and 116, 118 may choose to either utilize the physical venue 108 or utilize the online space 104 and there may be fewer or greater members at any given time.

In yet another embodiment, the system 100 generates revenues. In one particular embodiment, the revenues are generated from advertisements. The advertiser 102 may promote their wares either on the online space 104, the physical venue 108, or both. In another particular embodiment, the revenues are generated from partnerships. The partner 110 may be a music, concert, dance, or show production. In yet a further particular embodiment, the revenues are generated from membership fees from members who access the online space 104 or the physical venue 108. In another embodiment, the revenues are generated from the physical venue 108 sales such as liquor, food, or cigarettes.

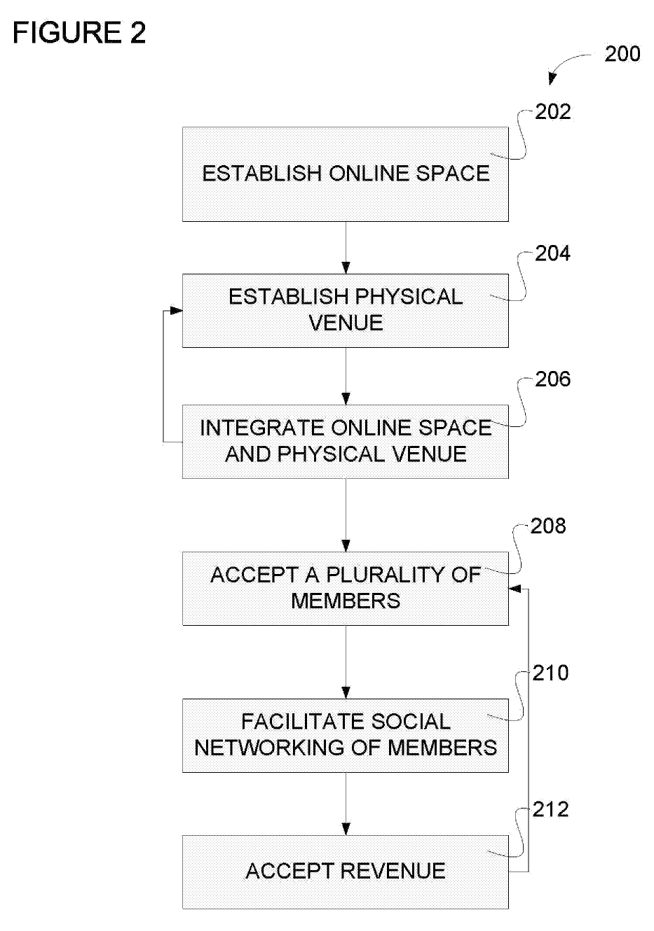

FIG. 2 is a block diagram of a method for bridging an online space and an offline physical venue, in accordance with an embodiment of the invention. In one embodiment, the method 200 includes the steps of establishing an online space at block 202, establishing a physical venue at block 204, integrating the online space and the physical venue at block 206, accepting a plurality of members at block 208, facilitating social networking of members at block 210, and accepting revenue at block 212.

In one embodiment, the establishing an online space at block 202 includes establishing an internet application that permits online communication between a plurality of members. In one particular embodiment, the internet application is configurable to establish a user account containing personal information for each of the plurality of members. The internet application then provides tools for each of the plurality of members to filter, search, and review the personal information and communicate with one another. In another particular embodiment, the internet application is configurable to accept a membership fee. In an alternative embodiment, the internet application provides for limited guest services such as browsing and free time trials.

In another embodiment, the establishing a physical venue at block 204 includes providing a physical location configurable for at least one of the plurality of members to socially gather, such as with dancing, entertainment, business interacting, games, learning, consuming beverages, enjoying music, conversing, viewing events, or any other activity. In certain embodiments, the physical venue is owned by the same entity that owns the online space. In other embodiments, the physical venue is franchised, leased, or rented. In one particular embodiment, the plurality of members are permitted to gain access to the physical venue after confirming their user account. In one particular embodiment, the physical venue provides limited guest services, such as limited time passes or visits, whereby a non-member is permitted to gain access to the physical venue. In another particular embodiment, the physical venue further includes specialized services such as valet parking, personal introductions by staff, private meeting rooms, internet, television, business services, discounts, or other useful service.

In yet another embodiment, the integrating the online space and physical venue at block 206 includes providing a system whereby a member present at the physical venue can electronically interact with a member not present at the physical venue and a member present at the physical venue can electronically interact with another member present at the physical venue. Thus, the system supplements electronic interactions purely over the online space and physical interaction at the physical venue. In one particular embodiment, the system permits a member not present at the physical venue to determine which members are physically present at the physical venue. The non-physically present member is permitted to review the personal information of the physically present members, communicate with, schedule an appointment with, or physically arrive and meet with any physically present member. In one particular embodiment, the system provides automatic notification to a non-physically present member of a particular member's intent to be physically present or actual arrival at the physical venue. In an alternative embodiment, a non-physically present member may electronically interact with another non-physically present member and optionally schedule a meeting at the physical venue or may indicate an intent to arrive at the physical venue. In another particular embodiment, the system permits a physically present member to manifest a physical presence at the physical venue to permit another member to determine which members are physically present. In certain embodiments, the manifestation is through a check in process prior to entering the physical venue. In another particular embodiment, an identification system is implemented to permit a physically present member to interact with another physically present member. In certain embodiments, the identification system is a visible label or electronic identification. Thus, one physically present member can locate another physically present member, learn about the other member through their personal information associated with their identification, and electronically interact with the other member prior to actually physically meeting. In certain particular embodiments, the method 200 may optionally return to establishing another physical venue at block 204.

In another embodiment, the accepting a plurality of members at block 208 includes establishing a user account having personal information for a plurality of individuals. In certain embodiments, the establishing a user account further includes accepting a fee. In another embodiment, the establishing a user account includes issuing an identification card. In another embodiment, the facilitating the social networking of the members at block 210 includes permitting the members to interact with one another using the online space, the physical venue, and the integration system as outlined above. In yet another embodiment, the accepting revenue at block 212 includes any of accepting membership fees, accepting physical venue revenue, such as for food, drinks, cigars, and music, accepting advertising revenue online or at the physical venue, and accepting partnership revenue. In certain particular embodiments, the method 200 may optionally return to accepting additional members at block 208.

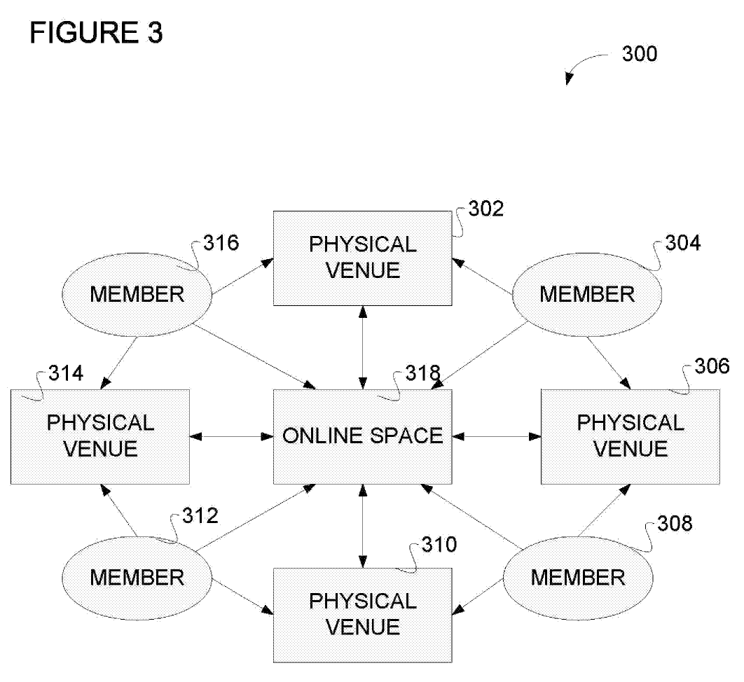

FIG. 3 is a block diagram of a system for bridging an online space and a plurality of physical venues, in accordance with an embodiment of the invention. In one embodiment, the system 300 includes a plurality of physical venues 302, 306, 310, and 314, an online space 318, and a plurality of members 304, 308, 312, and 316. The system 300 may include fewer or greater numbers of members or physical venues so the illustration is by way of example. In certain embodiments, the physical venues are substantially identical. In other embodiments, one or more of the physical venues serve various distinct purposes. For instance, one physical venue may be a bar while another physical venue may be a golf course. In one particular embodiment, any of the plurality of members 304, 308, 312, and 316 may optionally visit any of the plurality of physical venues 302, 206, 310, and 314 and interact with any physically present members or non-physically present members using any of the systems and methods disclosed in reference to FIGS. 1 and 2.

In one embodiment, a member may wear an identification anywhere, including around town, while shopping, at school, on a street, at a coffee shop, at a bar, or any other conceivable physical space. The identification may be either visible or hidden from view and may include an electronic transmission. Another individual can either read the identification visually or with the aid of another device and use the identification information to learn about the member with information stored online. The member can pre-associate their information with the identification so that others can later view the information. Thus, individuals can pass people on the streets, or anywhere else, obtain an identification and look up information on a particular member. The individual can contact that member and possibly arrange a meeting. In certain embodiments, this service includes a fee.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system for bridging online and offline communication, the system comprising:
an online space, the online space configurable to establish member accounts for a plurality of members, the member accounts configurable to being associated with personal information about corresponding members, the online space configurable to permitting online interaction among the plurality of members;
a physical venue, the physical venue configurable to being a social place with access limited to the plurality of members, the physical venue being configurable to permit physical interaction among the plurality of members, and
an integration system, the integration system configurable to permit online interaction between any of the plurality of members physically present at the physical venue and any other of the plurality of members physically present at the physical venue and between any of the plurality of members physically present at the physical venue and any of the plurality of members using on the online space.

2. The system of claim 1 wherein the integration system is configurable to providing information to any of the plurality of members as to which of the plurality of members are physically present at the physical venue.

3. The system of claim 2 wherein the integration system is configurable to notifying any of the plurality of members when one of the plurality of members is physically present at the physical venue.

4. The system of claim 3 wherein the integration system is configurable to receiving a status setting from any of the plurality of members at the physical venue, the status setting indicating whether a member is available for physical interaction.

5. The system of claim 2 wherein any of the plurality of members present at the physical venue carry an identification to permit the plurality of members present at the physical venue to access personal information of the any of the plurality of members on the online space.

6. The system of claim 5 wherein the identification is present on any of a label, a glass, and an electronic transmitter.

7. The system of claim 2 wherein the plurality of members present at the physical venue carry a tracking device to assist in determining a physical position of the plurality of members present at the physical venue.

8. The system of claim 1 wherein any of the plurality of members can limit accessible personal information.

9. The system of claim 1 wherein the physical venue is any of a bar, restaurant, lounge, club, theatre, and coffee shop.
